(19) United States
(12) Patent Application Publication
(10) Pub. No.: US 2018/0059863 A1
(43) Pub. Date: Mar. 1, 2018

(54) CALIBRATION OF PEN LOCATION TO PROJECTED WHITEBOARD

(71) Applicant: Lenovo (Singapore) Pte. Ltd., New Tech Park (SG)

(72) Inventors: Scott Wentao Li, Cary, NC (US); Bruce Douglas Gress, Raleigh, NC (US); Shayesteh Kamrani Sims, Cary, NC (US); David Williams Higgins, Cary, NC (US)

(21) Appl. No.: 15/248,418

(22) Filed: Aug. 26, 2016

(51) Int. Cl. G06F 3/041; G06F 3/0354; G06F 3/042; H04N 5/33

(52) U.S. Cl. CPC G06F 3/0418; G06F 3/03545; H04N 5/332; G06F 3/0421; G06F 3/0425

(57) ABSTRACT

In one aspect, a device includes a processor, a visible light detector, an infrared (IR) detector, a projector, and storage accessible to the processor. The storage bears instructions executable by the processor to actuate the projector to project calibration images onto a projected whiteboard location and receive, from the visible light detector, at least one image of the calibration images. The instructions are also executable to receive at least one image of an IR emitter on a pen from the IR detector and calibrate a location of the IR emitter with respect to the projected whiteboard using the at least one image from the visible light detector and at least one image of an emitter on the pen.

### FIELD

The present application relates generally to calibrating pen location to the position of a projected whiteboard.

### BACKGROUND

As recognized herein, projector assemblies on computerized devices can be used to project a whiteboard onto a surface. A person can ghost write onto the projected whiteboard by moving, in free space, a pen with an infrared (IR) emitter on it. The projector includes an IR detector (the detecting portion of an IR “tracker”) so that movement of the pen in free space is tracked by means of its IR emitter, and the movement is correlated to pen strokes which can then be projected onto the whiteboard, as if the person were manually writing on a physical whiteboard.

Typically, projected whiteboard systems require calibration of the projector's IR tracker in software before use, so that the projected writing derived from the motion of the pen can be accurately projected onto the surface at the location of the whiteboard that the writer appears to be writing on. As understood herein, however, calibration is diminished or lost should the projector be moved, as by inadvertent bumping, etc. during use. Because many whiteboard projector systems are incorporated into smaller mobile devices such as tablet computers, such inadvertent moving or bumping can be a frequent occurrence, requiring the user to bear the nuisance of re-calibrating the system.

### SUMMARY

Accordingly, in one aspect a device includes a processor and storage accessible to the processor. The device also includes a projector, a visible light detector, and an infrared (IR) detector. The storage bears instructions executable by the processor to actuate the projector to project calibration images onto a projected whiteboard location. The instructions are executable to receive at least one image of the calibration images from the visible light detector and also to receive at least one image of an IR emitter on a pen from the IR detector. The instructions are executable to calibrate a location of the IR emitter with respect to the projected whiteboard using the at least one image from the visible light detector and at least one image of an emitter on the pen.

In some embodiments, the at least one image of an emitter on the pen may be of a visible light emitter on the pen. In such an embodiment, the instructions may be executable to calibrate a location of the visible light emitter to the projected whiteboard in visible space by determining respective offsets of the image of the visible light emitter in an x-dimension and a y-dimension from a reference defined by the calibration images. The instructions may be further executable to calibrate at least one location of the projected whiteboard in IR space by applying the respective offsets to the at least one image of the IR emitter from the IR detector.

In other embodiments, the at least one image of an emitter on the pen may be the least one image of the IR emitter of the pen, and no visible emitter image from the pen may be used.

The calibration images may represent respective corners of the projected whiteboard.

If desired, the IR detector may be characterized by a resolution and field of view (FOV), and the visible light detector may have a FOV that is the same as the FOV of the IR detector. Further, the visible light detector may have a resolution that is the same as the resolution of the IR detector. Additionally, the IR detector can be closely juxtaposed with the visible light detector.

In another aspect, a computer readable storage medium (CRSM) that is not a transitory signal includes instructions executable by a processor to image an infrared (IR) emitter on a hand-held device, and to associate a location of the IR emitter with plural locations of a projected whiteboard imaged by a visible light detector.

In another aspect, a method includes projecting plural visible images onto respective corner regions associated with a projected whiteboard. The method also includes receiving reflections of the visible images by a visible light detector, receiving at least one image of an emitter on a hand-held device, and correlating a location of the emitter on the hand-held device with locations in the visible images using the reflections of the visible images by the visible light detector.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIG. 3 is a schematic diagram of a projector and pen according to present principles;

FIG. 4 is a flow chart of example logic; and

FIGS. 5-7 are schematic diagrams of, respectively, imaged visible space, imaged IR space, and calibrated IR space during an example calibration process.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

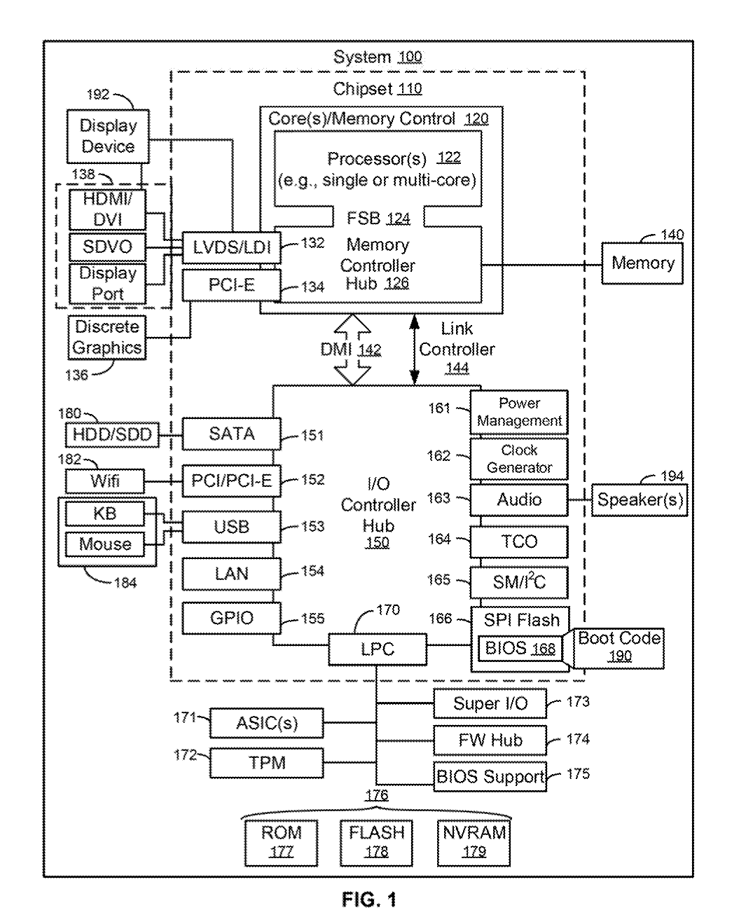

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB) and mice, microphones and various other devices (e.g., cameras including both visible spectrum cameras an infrared cameras such as forward looking infrared (FLIR) cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera such as mentioned above for the input device 184 that gathers one or more visible and/or IR images and provides input related thereto to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. Still further, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

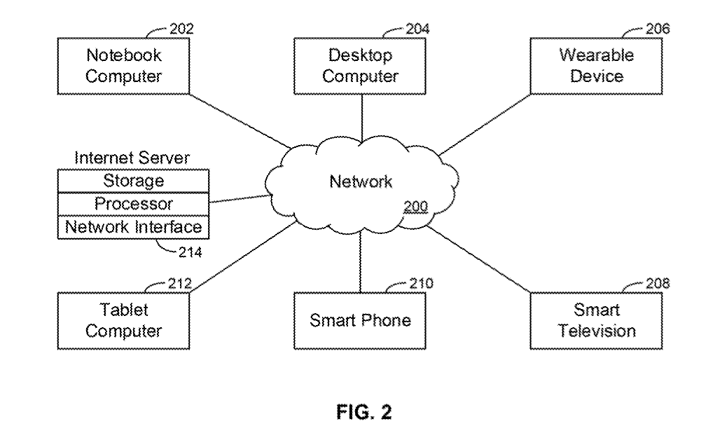

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

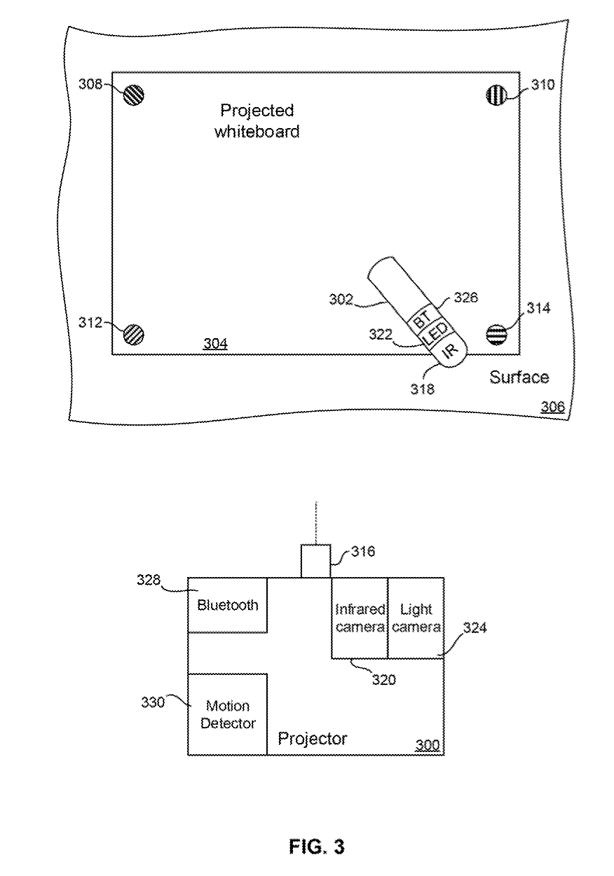

FIG. 3 is a schematic diagram of a projector 300, such as may be implemented by a tablet computer incorporating any of the components discussed above as well as those specifically shown and discussed, and a pen 302, also incorporating any of the components discussed above as well as those specifically shown and discussed. In the example shown, the projector 300 projects an image 304 of a whiteboard onto a surface 306. For calibration purposes, the projector can also project at least one and preferably four color (e.g., blue, or green, or other visible color) dots 308, 310, 312, 314 onto the surface 306, preferably at known locations with respect to the whiteboard being projected. In the preferred example shown, the dots 308-314 are projected at respective corners of the projected whiteboard 304. The dots 308-314 are in the visible spectrum, not in the IR spectrum.

Because existing whiteboard projectors have color projectors such as the color projector 316, programming the projector 300 to project the dots 308-314 does not require the addition of an additional projector such as an IR projector.

The pen 302 typically includes an IR transmitter 318 such as a diode, the IR light from which is detected by an IR detector such as an IR camera 320, typically mounted on the projector 300. In some embodiments, the pen 302 may also include a visible light emitter 322 such as a light emitting diode (LED), light from which can be detected by a visible light camera or other visible light detector 324 on the projector 300. The pen 302 and projector 300 may also incorporate respective short range wireless radiofrequency (RF) transceivers 326, 328 for RF communication with each other. As alluded to above, the pen 302 and projector 300 may include respective processors, storage media, and other components shown in FIGS. 1 and 2 and discussed above. The projector 300 may also include a motion detector 330 such as a gyroscope or accelerometer.

In the example shown, the visible light emitter 322 and IR transmitter 318 are mounted very close to each other on the pen 300, e.g., within a millimeter of each other, so that detection of light from the visible emitter 322 essentially indicates the location (within a very close range) of the IR transmitter 318. The IR transmitter 318 is typically mounted on the end of the pen 302 that a user would normally hold closest to the projector, i.e., the end opposite the end with which the user is expected to ghost write onto the whiteboard 304. Thus, to simplify computation the location of the visible light emitter 322 can be assumed to be the same as the location of the IR emitter 318. It will readily be appreciated that in embodiments in which the visible and IR emitters 318, 322 are not closely juxtaposed with each other, and/or in embodiments in which the tolerance for precise IR emitter location is desired to be very small, an offset can be added to the detected location of the visible emitter 322 to account for the distance between the visible emitter 322 and IR emitter 318.

Not only may the pen emitters 318, 322 be mounted in very close proximity to each other, but for further computation simplicity the cameras 320, 324 on the projector 300 also are preferably mounted in close proximity to each other. Further, the visible light camera 324 can have the same field of view (FOV) and resolution as the IR camera 320. For example, the resolution of both cameras 320, 324 may be 1024×768, and the FOV of both cameras may be 45 degrees in the same direction as each other. The close proximity of the cameras in being mounted right next to each other on the projector 300 ensures non-overlap area coverage, essentially close to zero, to further reduce calculation complexity. However, as was the case with the pen emitters, offsets can be added to detected locations of the dots 308-314 from the visible camera 324 to account for the distance between the cameras 320, 324, to arrive at dot locations relative to the location of the IR camera 320.

It is to be understood that the dots 308-314 are but an example of calibration images that may be projected onto the surface 306 along with the projected whiteboard 304. Other visible light shapes and/or patterns may also be used.

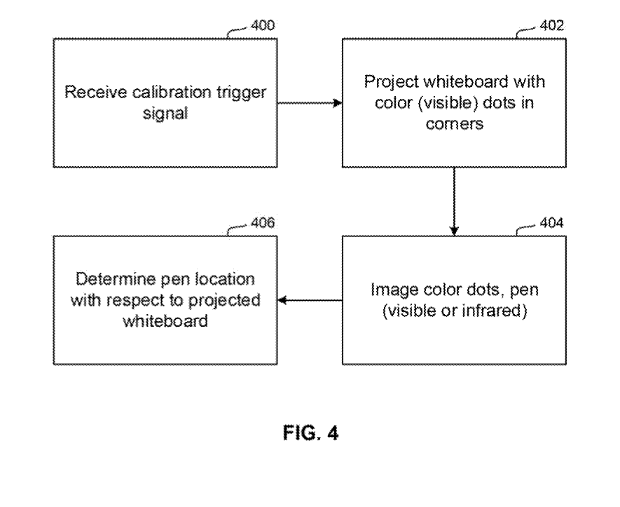

Referring to FIG. 4, logic is illustrated that may be performed by any of the devices discussed herein, preferably by the projector 300. The calibration logic commences at state 400 in which a calibration trigger signal is received to cause logic to move to block 402 to project onto a surface such as the surface 306 the projected whiteboard 304, along with the calibration images, e.g., the dots 308-314.

The calibration trigger may be, upon first projecting the whiteboard 304 onto the surface 306, e.g., at the beginning of every whiteboard projection session. In addition or alternatively, the calibration trigger may be a signal from the motion detector 330 indicating movement of the projector 300 above a threshold. In addition or alternatively, the calibration trigger may be every “N” seconds, wherein “N” is an integer greater than zero, in other words, calibration may be executed automatically at regular time intervals. Yet again, in addition or alternatively, the calibration trigger may be user-initiated by means of inputting a calibration command on an input device. In addition or alternatively, the calibration trigger may be every detected motion of the pen 302 by, e.g., the IR camera 320.

Proceeding from block 402 to block 404, the calibration images 308-314 are imaged by the visible light camera 324. Using the example shown in FIG. 3, by imaging the dots 308-314, the signal from the visible light camera 324 indicates to the projector processor the actual locations in space of the corners of the whiteboard 304.

Also, in embodiments in which a visible light emitter 322 is incorporated into the pen 302, at block 406 the visible light camera 324 detects the light from the emitter which is used by the processor of the projector to determine the location of the (typically near) end of the pen 302. It will readily be appreciated that the images from the visible light camera 324 are in the same frame processed by the processor of the projector, meaning that the location of the pen tip can be correlated to the locations of the calibration images 308-314 to thereby calibrate the projector 300 in that the projector 300 now knows the actual location of the pen tip with respect to the corners of the whiteboard 304 as actually projected onto the surface 306.

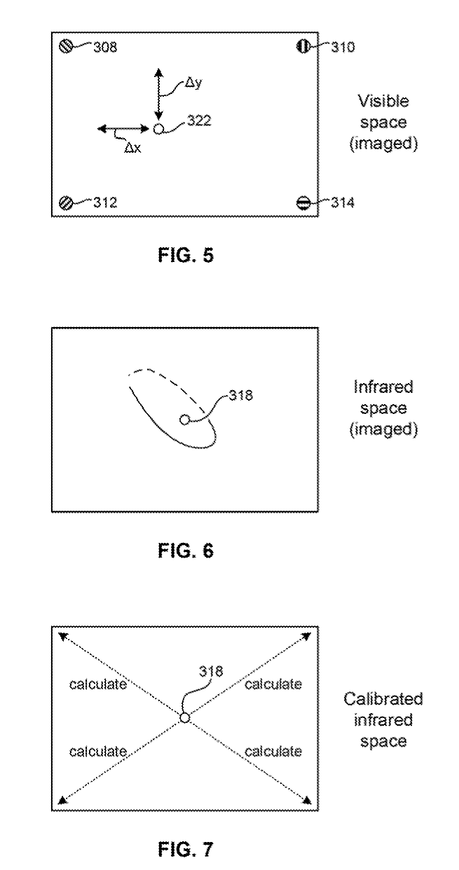

In mathematical terms and referring to FIG. 5, if the dots 308-314 are imaged at respective locations xᵢ, yᵢ, i=1 to 4 in the x-y plane, and the upper left dot 308 is at reference location (0, 0) with the pen tip location within the rectangle defined by the dots 308-314, then the distance Δx in the x dimension of the visible emitter 322 from the left edge of the rectangle defined by the dots 308-314 can be determined from the image taken by the visible camera 324. Likewise, the distance Δy in the y dimension of the visible emitter 322 from the top edge of the rectangle defined by the dots 308-314 can be determined from the image taken by the visible camera 324. Pen position may be represented by xₚ, yₚ.

Thus, in this example:

x₁,y₁=(xₚ−Δx,yₚ−Δy)

x₂,y₂=(xₚ+Δx,yₚ−Δy)

x₃,y₃=(xₚ−Δx,yₚ+Δy)

x₄,y₄=(xₚ+Δx,yₚ+Δy)

In this way, the location of the visible emitter 322 is calibrated in visible space to the corners of the projected whiteboard.

Simultaneously with imaging the calibration images 308-314 and visible emitter 322 using the visible light camera 324 and referring to FIG. 6, an image of the IR emitter 318 may be taken by the IR camera 320. As mentioned above, an offset may be applied to the imaged location of the IR emitter 318 to account for the otherwise negligible distance between the emitters if desired, but for computational simplicity it may simply be assumed that the emitters of the pen are co-located. In any case, once the IR emitter location is established (with or without an offset, as desired) and referring to FIG. 7, the locations of the corners of the projected whiteboard in IR space are calculated by applying the equations above to the location of the pen tip as indicated by the IR image of the IR emitter 318.

During subsequent post-calibration operation, the visible calibration images 308-314 may be removed if desired (not projected) and the image of the IR emitter 318 only being taken by the projector 300. The projector 300 maps the IR-imaged location of the pen tip to the corners of the whiteboard in IR space to know where to project handwriting derived from imaged IR motion of the pen tip onto the whiteboard using the calibrated location of the corners of the whiteboard in IR space as discussed above.

In an alternate embodiment, the visible light emitter 322 may be omitted from the pen 302. In such an embodiment, calibration steps 400 and 402 in FIG. 4 may remain unchanged, with calibration step 404 simply replacing imaging of the IR emitter 318 for imaging a visible emitter and assuming that the visible and IR cameras 324, 320 have identical fields of view. The imaged location of the IR emitter 318 by the IR camera 320 may thus be superimposed into the imaged visible space, and the equations above used at block 406 to determine, using the location of the imaged IR emitter, its position relative to the corners of the projected whiteboard.

Moving on from FIGS. 5-7, it is to be understood in accordance with present principles that a user interface (UI) may be presented on a display controlled by a device configured to execute the logic above. The UI may be for configuring settings of such a device, and may include at least a first option that is selectable from the UI to configure the device to undertake present principles (e.g., selectable to configure the device to automatically perform calibrations as set forth herein, such as responsive to sensing that the projector has moved or been bumped).

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor;
a visible light detector;
an infrared (IR) detector;
a projector;
storage accessible to the processor and bearing instructions executable by the processor to:
actuate the projector to project calibration images onto a projected whiteboard location;
receive, from the visible light detector, at least one image of the calibration images;
receive, from the IR detector, at least one image of an IR emitter on a pen; and
calibrate a location of the IR emitter with respect to the projected whiteboard using the at least one image from the visible light detector and at least one image of an emitter on the pen.

2. The device of claim 1, wherein the at least one image of an emitter on the pen comprises at least one image of a visible light emitter on the pen.

3. The device of claim 1, wherein the calibration images represent respective corners of the projected whiteboard.

4. The device of claim 1, wherein the IR detector is characterized by a resolution and field of view (FOV), and wherein the visible light detector has a FOV that is the same as the FOV of the IR detector.

5. The device of claim 4, wherein the visible light detector has a resolution that is the same as the resolution of the IR detector.

6. The device of claim 1, wherein the IR detector is closely juxtaposed with the visible light detector.

7. The device of claim 2, wherein the instructions are executable by the processor to:
calibrate a location of the visible light emitter to the projected whiteboard in visible space by determining respective offsets of the image of the visible light emitter in an x-dimension and a y-dimension from a reference defined by the calibration images;
calibrate at least one location of the projected whiteboard in IR space by applying the respective offsets to the at least one image of the IR emitter from the IR detector.

8. The device of claim 1, wherein the at least one image of an emitter on the pen is the least one image of the IR emitter of the pen, no visible emitter image from the pen being used.

9. The device of claim 1, comprising the pen.

10. A computer readable storage medium (CRSM) that is not a transitory signal, the computer readable storage medium comprising instructions executable by a processor to:
image an infrared (IR) emitter on a hand-held device; and
associate a location of the IR emitter with plural locations of a projected whiteboard imaged by a visible light detector.

11. The CRSM of claim 10, wherein the instructions are executable by the processor to:
actuate a projector to project calibration images onto a projected whiteboard location;
receive, from the visible light detector, at least one image of the calibration images;
receive, from an IR detector, at least one image of the IR emitter; and
associate the location of the IR emitter with plural locations of the projected whiteboard at least in part by:
calibrating a location of the IR emitter with respect to the projected whiteboard using the at least one image from the visible light detector and at least one image of an emitter on the hand-held device.

12. The CRSM of claim 11, wherein the at least one image of an emitter on the hand-held device comprises at least one image of a visible light emitter on the hand-held device.

13. The CRSM of claim 12, wherein the instructions are executable by the processor to:
calibrate a location of the visible light emitter to the projected whiteboard in visible space by determining respective offsets of the image of the visible light emitter in an x-dimension and a y-dimension from a reference defined by the calibration images;
calibrate at least one location of the projected whiteboard in IR space by applying the respective offsets to the at least one image of the IR emitter from the IR detector.

14. The CRSM of claim 12, wherein the at least one image of an emitter on the hand-held device is the least one image of the IR emitter of the hand-held device, no visible emitter image from the hand-held device being used.

15. The CRSM of claim 11, comprising the projector, the visible light detector, and the IR detector.

16. A method, comprising:
projecting plural visible images onto respective corner regions associated with a projected whiteboard;
receiving reflections of the visible images by a visible light detector;
receiving at least one image of an emitter on a hand-held device; and
correlating a location of the emitter on the hand-held device with locations in the visible images using the reflections of the visible images by the visible light detector.

17. The method of claim 16, wherein the at least one image of an emitter on the hand-held device comprises at least one image of a visible light emitter on the hand-held device.

18. The method of claim 17, comprising:
calibrating a location of the visible light emitter to the projected whiteboard in visible space by determining respective offsets of the image of the visible light emitter in an x-dimension and a y-dimension from a reference defined by the calibration images.

19. The method of claim 18, comprising
calibrating at least one location of the projected whiteboard in IR space by applying the respective offsets to the at least one image of the IR emitter from the IR detector.

20. The method of claim 16, wherein the at least one image of an emitter on the hand-held device is the least one image of the IR emitter of the hand-held device, no visible emitter image from the hand-held device being used.
